(19) United States
(12) Patent Application Publication
(10) Pub. No.: US 2023/0214357 A1
(43) Pub. Date: Jul. 6, 2023

(54) CONTEXT AWARE FILE NAMING CONVENTIONS

(71) Applicant: International Business Machines Corporation, Armonk, NY (US)

(72) Inventors: Partho Ghosh, Kolkata (IN); Saraswathi Sailaja Perumalla, Visakhapatnam (IN); Subha Kiran Patnaikuni, Visakhapatnam (IN); Raghupatruni Nagesh, Visakhapatnam (IN)

(21) Appl. No.: 17/647,028

(22) Filed: Jan. 5, 2022

(51) Int. Cl. G06F 16/16; G06N 3/08

(52) U.S. Cl. CPC G06F 16/164; G06N 3/08

(57) ABSTRACT

Determining a name for a given file using file naming convention techniques based upon the context of the given file. The given file can include digital data and media content. In some instances, the context of the digital data and media content can be determined by using Natural Language Processing (NLP) to extract the substantive content of the digital data and Artificial Intelligence (AI) to properly classify the substantive content.

### BACKGROUND

The present invention is generally related to the field of file systems, and specifically to managing and organizing files in large-scale enterprise level file systems.

The Wikipedia entry for the term “Filename” (as of Dec. 8, 2021) states as follows: “A filename or file name is a name used to uniquely identify a computer file in a directory structure. Different file systems impose different restrictions on filename lengths and the allowed characters within filenames.”

This entry further states as follows: “A filename may (depending on the file system) include one or more of these components: host (or server)—network device that contains the file, device (or drive)—hardware device or drive, account (or owner)—the account number or name of the user it is owned by, directory (or path)—directory tree, file—base name of the file, type (format or extension)—indicates the content type of the file (e.g. .txt, .exe, .COM, etc.), version—revision or generation number of the file, numerical identifier—widely used by digital cameras (DCF standard), date and time stamp—widely used by smartphone camera software and for screenshots, [and/or] short comment—such as the name of a subject or a location, which may be added manually, to facilitate finding files. The components required to identify a file varies across operating systems, as does the syntax and format for a valid filename.”

### SUMMARY

According to an aspect of the present invention, there is a method, computer program product and/or system that performs the following operations (not necessarily in the following order): (i) receiving a first plurality of files, with the first plurality of files including digital data and media content; (ii) determining, for each given file of the plurality of files, a context of the plurality of files based on the digital data and media content; (iii) generating, by a file naming convention module and for each given file of the plurality of files, a file name for the given file based, at least in part, upon the determined context; and (iv) responsive to the generating of the first file name, assigning the file name to the given file, with the file name being included in a file metadata.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a block diagram showing information that is helpful in understanding embodiments of the present invention; and

FIG. 5 is a block diagram showing information that is helpful in understanding embodiments of the present invention.

### DETAILED DESCRIPTION

Some embodiments of the present invention are directed towards determining a name for a given file using file naming convention (FNC) techniques based upon the context of the given file. The given file can include digital data and media content. In some instances, the context of the digital data and media content can be determined by using Natural Language Processing (NLP) to extract the substantive content of the digital data and Artificial Intelligence (AI) to properly classify the substantive content.

This Detailed Description section is divided into the following sub-sections: (i) The Hardware and Software Environment; (ii) Example Embodiment; (iii) Further Comments and/or Embodiments; and (iv) Definitions.

### I. THE HARDWARE AND SOFTWARE ENVIRONMENT

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

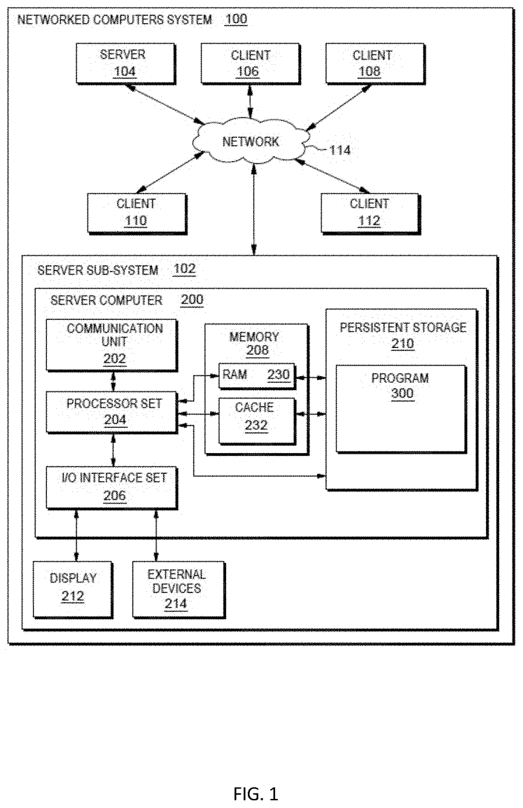

An embodiment of a possible hardware and software environment for software and/or methods according to the present invention will now be described in detail with reference to the Figures. FIG. 1 is a functional block diagram illustrating various portions of networked computers system 100, including: server sub-system 102; client sub-systems 104, 106, 108, 110, 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

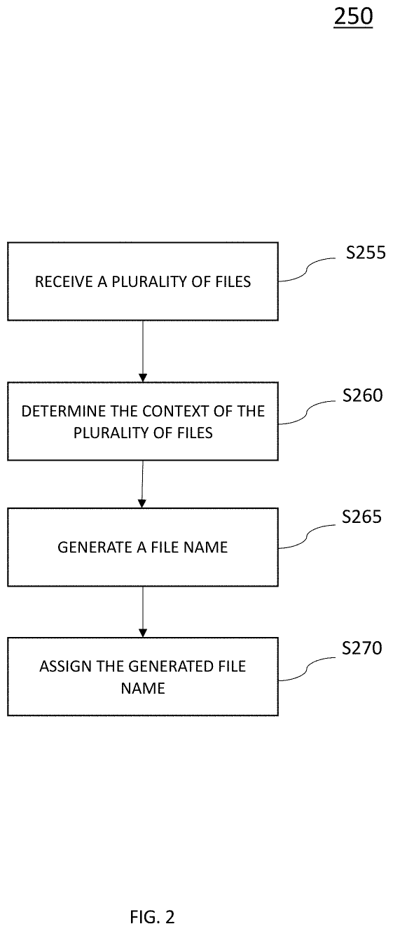

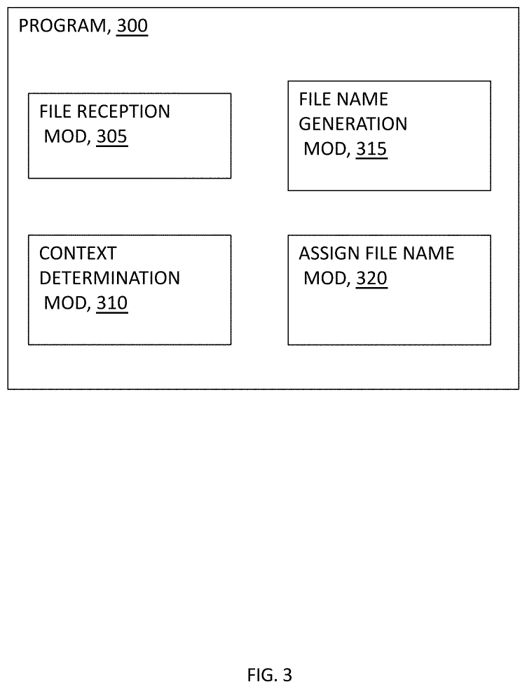

FIG. 2 shows flowchart 250 depicting a method according to the present invention. FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks).

Processing begins at operation 5255, where file reception module (“mod”) 305 receives a first plurality of files. In this example, the files are all related to a particular topic, event, user, or other frame of reference. The files may be received as a batch or as individual files or sets of files designated as belonging to a parent batch of files. In some embodiments, the files include both digital data and media content.

Processing proceeds to operation 5260, where context determination mod 310 determines a context of the plurality of files. In this example, the context of the files relates to the frame of reference in which it is grouped and what role the individual file plays in that frame of reference. A sequence number is a simple example of how the context may be assigned. A series of dated documents can be associated with a development project. The context of each file may be simply the date of the documents. While this simple example illustrates how the context determination works, the actual determination may be far more nuanced depending on the artificial intelligence mechanisms on which the determination is based.

Processing proceeds to operation 5265, where file name generation mod 315 generates a set of file names for the plurality of files based upon the context of each file. During digitisation, it is easy to simply make up names as you save each digital file. However, as the number of files increases this quickly breaks down, it becomes difficult to remember which files belong to which digital object or what parts of the object content they contain. Files should be named using a convention that identifies the digital object to which the file belongs and how it is related to other components of the digital object, such as by a sequence number or a related date.

Some embodiments of the present invention analyze existing file structures where the file is created or dynamically saved based on AI techniques and determine a third set of relevant metadata, intents, and entities catering to the file and folder structure. Additionally, some embodiments would enable an AI based file naming convention framework from multi-faceted metrics along with an historical corpus of convention practices wherein the system generates one and/or many rules that define a file name in many formats.

Processing finally proceeds to operation 5270, where assign file name mod 320 assigns generated file names to the corresponding files of the plurality of files. In some embodiments, the generated file names for the corresponding files are based upon the results of a trained AI and/or deep neural network that accurately determines a file name based on the learned correlation between the content of the file and the proper file naming conventions for files containing the content.

### III. Further Comments and/or Embodiments

When dealing with digital data and media, and there is a greater need to suggest improved file names, file naming practices, and conventions in order to maximize organization, making files easier to find, making them more useable and more easily shared.

In most computer systems, names are used to identify files. As an identifier, filenames are an important piece of metadata. Data organization provides a structure to allow a user when researching data.

Using an improved file name and a file naming convention (FNC) is a simple way to organize files. This approach gives each file a unique name that describes both its contents and its relation to other files. The convention can be used for both physical and digital files.

In most computer systems, names are used to identify files. As an identifier filenames are an important piece of metadata. During digitisation, it is easy to simply create names as a user saves each digital file. However, as the number of files increases this quickly breaks down and it becomes difficult to remember which files belong to which digital object or what parts of the object content they contain. Files ideally should be named using a convention that identifies the digital object to which the file belongs and how it is related to other components of the digital object (such as a sequence number).

Considering the need to arrange and manage files that would not only be able to enhance the search algorithms in a user's device and/or the cloud, embodiments of the present invention also enables dynamic assistant based searches. Given the urgent need to manage files, embodiments of the present invention provide a system and method to generate context based file naming conventions and validation.

Embodiments of the present invention identify the need for creating a file, type of file creation, etc. triggered by a user and/or users, file system, cloud or social media system wherein the need of new file creation would be clicking a picture, taking a screen shot, uploading or downloading a file from cloud or virtual directory, creating a text file, a presentation type file, or even generating a codebase file. For example, consider the following actions that can be taken by a user: click a picture, take a screen shot, create a text file, save a chat file that is shared over a chat messaging service.

Embodiments of the present invention will identify the contextual intention of the user for creating a file based on the context of file need. In some embodiments, the system identifies a first set of relevant metadata, intents and entities catering to the file creation contextual need.

Embodiments of the present invention will also analyze the content and metadata of a newly generated file including: intent, entities, size, and/or file type. Analysis may be based on an Artificial Intelligence (AI) file analysis engine (such as Natural Language Processing (NLP), Deep Learning, document parsing, etc.) and thereby identify a second set of relevant metadata, intents, and entities catering to the file content (including picture content, word content, etc.).

In addition, embodiments of the present invention will also alert the user based on the confidentiality of the file in order to provide relevant access to analyze the content.

Some embodiments of the present invention analyze existing file structures where the file is created and/or dynamically saved based on AI techniques and determines a third set of relevant metadata, intents, and entities catering to the file and folder structure. Additionally, some embodiments would enable an AI based file naming convention framework from multi-faceted metrics (discussed above) along with an historical corpus of convention practices wherein the system generates one rule or multiple rules that define a file name in various formats.

Some embodiments of the present invention enable a validation and recommendation engine which would provide a file name or folder name given by the user and correlate this given name with the file naming conventions to auto verify and notify the user for any mis-naming practices. Additionally, embodiments of the present invention would recommend alternate naming in adherence to the user given name and naming conventions. Based on the multi-faceted file creation contextual need, file content, folder structure, metadata sets, embodiments of the present invention will be able to recommend appropriate default file names of the created or generated file.

Some embodiments of the present invention recommend appropriate version details based on reuse and resave patterns of one (or more) or a combination of existing files in the file system, virtual directories or cloud directories. In addition, some embodiments will be able to generate a corpus of multifarious file naming conventions that correspond to their contexts, metatags, and validators. Additionally, some embodiments use transfer learning for the following corpuses in multiple contexts of file systems and services such as cloud drives, messaging services, etc.

Some embodiments of the present invention enable an assistant for an efficient file fetching system. In this system, using the natural language inputs of the user, the system correlates the intents and entities from an assistant system to correlate with the file metadata. The system would further enable AR and Voice based assistants to enable and enhance the search algorithms in the device, cloud, and other services for file systems.

Some embodiments of the present invention use a virtual file system wherein the file content, screenshot, captured picture, etc. is copied into a local sandbox. The virtual file system leverages a native file system API for handling specialized functions such as metadata management, context capturing, record management, directory management, and sharing.

Metadata extraction tools are used to systematically extract preservation metadata from a range of file formats such as PDF (for documents), image files, sound files, text files, and many others. The metadata can be exported in a standard format (XML) for use in preservation activities.

In some embodiments, neural networks (both deep neural networks and shallow neural networks) are leveraged for classifying intent. This process involves analyzing file content and figuring out the specific purpose, intent or goal towards which the content is headed. The metadata extracted would also be used to find out the intent.

Some embodiments of the present invention train Artificial Intelligence (AI) models by presenting a context-aware file or video understanding technique that makes the machine intelligent enough to understand the message behind the file or video stream. The main purpose is to understand the file or video stream by extracting real meaningful concepts, emotions, temporal data, and spatial data from the file or video context. Additionally, some embodiments use a native file system API to restrict access by creating roles and imposing service accounts on the confidential content. The directory management system provided by the native file system is used to auto-organize the generated file based on the context or the intent of the file content.

Some embodiments of the present invention apply Recurrent Neural Network (RNN) techniques to train the names of the files based on the file naming convention framework. After successful training, the model predicts the file name that it is most likely to belong to the context/intent of the file content uploaded to a sandbox.

In some embodiments of the present invention, a recommendation engine is built using neural networks and dimensionality reduction techniques to learn user preferences based on a series of attributes obtained from previous file naming conventions. This recommendation engine uses metadata and the contextual data to analyze and determine the file names. Alternatively, the recommendation engine can rely on the file naming conventions by other users, which the recommendation engine then uses to compute a similarity index between users and recommends files to them accordingly. It is also possible to combine both these methods to build a much more robust recommendation engine.

In some embodiments of the present invention, a built-in file versioning system is used to create file versions automatically, transparently, and in a file-system portable manner-while maintaining underlying operating system (OS) semantics. Additionally, an AI personal assistant built using a text-to-speech library enhances the search capabilities by allowing the proposed system to use the intent, context and content stored in the virtual file system.

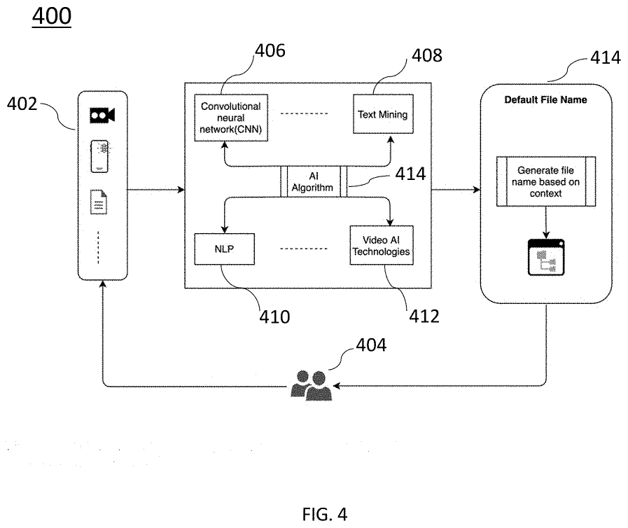

Diagram 400 of FIG. 4 is a high level architecture diagram of an embodiment of the present invention. Diagram 400 includes: files 402, users 404, convolutional neural network (CNN) module 406, text mining module 408, Natural Language Processing (NLP) module 410, video AI technologies module 412, and file generation module 414.

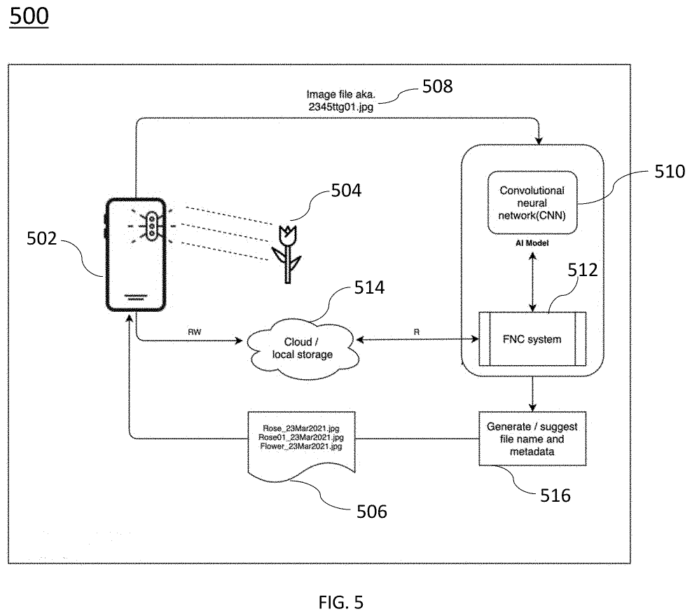

Diagram 500 of FIG. 5 shows a second architecture diagram of an embodiment of the present invention. Diagram 500 includes: camera 502, image 504, file set 506, file 508, CNN module 510, file naming convention (FNC) system 512, cloud and local storage 514, and file name generation module 516.

### IV. Defintions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

User/subscriber: includes, but is not necessarily limited to, the following: (i) a single individual human; (ii) an artificial intelligence entity with sufficient intelligence to act as a user or subscriber; and/or (iii) a group of related users or subscribers.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output/report: unless otherwise explicitly specified, these words should not be taken to imply: (i) any particular degree of directness with respect to the relationship between their objects and subjects; and/or (ii) absence of intermediate components, actions and/or things interposed between their objects and subjects.

Without substantial human intervention: a process that occurs automatically (often by operation of machine logic, such as software) with little or no human input; some examples that involve “no substantial human intervention” include: (i) computer is performing complex processing and a human switches the computer to an alternative power supply due to an outage of grid power so that processing continues uninterrupted; (ii) computer is about to perform resource intensive processing, and human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

Automatically: without any human intervention.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) comprising:
receiving a plurality of files including digital data and media content;
determining a context of a first file in the plurality of files based on the digital data and media content related to the first file;
generating, by a file naming convention module, a file name for a first file based, at least in part, upon the determined context of the first file; and
responsive to the generating of the file name, assigning the file name to the first file, with the file name being included in file metadata associated with the first file.

2. The CIM of claim 1 further comprising:
training a first artificial intelligence (AI) machine to obtain a first trained AI machine, with the first trained AI machine having learned the identity of the digital data and media content;
correlating the identity of the digital data and media content to a file naming convention; and
assigning the correlated identity of the digital data and media content as the file name for the first file.

3. The CIM of claim 1 further comprising:
determining, from the digital data and media content of the plurality of files, a set of file attributes; and
responsive to the determination of the set of file attributes, determining, by a recommendation engine, a set of file names for the plurality of files based, at least in part, upon user preferences.

4. The CIM of claim 1 further comprising:
determining, from the digital data and media content of the plurality of files, a set of file attributes; and
responsive to the determination of the set of file attributes, determining, by a recommendation engine, a set of file names for the plurality of files based, at least in part, upon file naming conventions.

5. The CIM of claim 1 wherein the generation of the file name for the first file is based, at least in part, upon using a trained deep neural network engine.

6. The CIM of claim 1 wherein the generation of the file name for the first file is based, at least in part, upon using a trained shallow neural network engine.

7. A computer program product (CPP) comprising:
a machine readable storage device; and
computer code stored on the machine readable storage device, with the computer code including instructions and data for causing a processor(s) set to perform operations including the following:
receiving a plurality of files including digital data and media content;
determining a context of a first file in the plurality of files based on the digital data and media content related to the first file;
generating, by a file naming convention module, a file name for a first file based, at least in part, upon the determined context of the first file; and
responsive to the generating of the file name, assigning the file name to the first file, with the file name being included in file metadata associated with the first file.

8. The CPP of claim 7 further comprising:
training a first artificial intelligence (AI) machine to obtain a first trained AI machine, with the first trained AI machine having learned the identity of the digital data and media content;
correlating the identity of the digital data and media content to a file naming convention; and
assigning the correlated identity of the digital data and media content as the file name for the first file.

9. The CPP of claim 7 further comprising:
determining, from the digital data and media content of the plurality of files, a set of file attributes; and
responsive to the determination of the set of file attributes, determining, by a recommendation engine, a set of file names for the plurality of files based, at least in part, upon user preferences.

10. The CPP of claim 7 further comprising:
determining, from the digital data and media content of the plurality of files, a set of file attributes; and
responsive to the determination of the set of file attributes, determining, by a recommendation engine, a set of file names for the plurality of files based, at least in part, upon file naming conventions.

11. The CPP of claim 7 wherein the generation of the file name for the first file is based, at least in part, upon using a trained deep neural network engine.

12. The CPP of claim 7 wherein the generation of the file name for the first file is based, at least in part, upon using a trained shallow neural network engine.

13. A computer system (CS) comprising:
a processor(s) set;
a machine readable storage device; and
computer code stored on the machine readable storage device, with the computer code including instructions and data for causing the processor(s) set to perform operations including the following:
receiving a plurality of files including digital data and media content;
determining a context of a first file in the plurality of files based on the digital data and media content related to the first file;
generating, by a file naming convention module, a file name for a first file based, at least in part, upon the determined context of the first file; and
responsive to the generating of the file name, assigning the file name to the first file, with the file name being included in file metadata associated with the first file.

14. The CS of claim 13 further comprising:
training a first artificial intelligence (AI) machine to obtain a first trained AI machine, with the first trained AI machine having learned the identity of the digital data and media content;
correlating the identity of the digital data and media content to a file naming convention; and
assigning the correlated identity of the digital data and media content as the file name for the first file.

15. The CS of claim 13 further comprising:
determining, from the digital data and media content of the plurality of files, a set of file attributes; and
responsive to the determination of the set of file attributes, determining, by a recommendation engine, a set of file names for the plurality of files based, at least in part, upon user preferences.

16. The CS of claim 13 further comprising:
determining, from the digital data and media content of the plurality of files, a set of file attributes; and
responsive to the determination of the set of file attributes, determining, by a recommendation engine, a set of file names for the plurality of files based, at least in part, upon file naming conventions.

17. The CS of claim 13 wherein the generation of the file name for the first file is based, at least in part, upon using a trained deep neural network engine.

18. The CS of claim 13 wherein the generation of the file name for the first file is based, at least in part, upon using a trained shallow neural network engine.
